(19) United States
(12) Patent Application Publication
(10) Pub. No.: US 2026/0011188 A1
(43) Pub. Date: Jan. 8, 2026

(54) VEHICLE SYSTEM AND METHOD FOR ASSESSING MACHINE HEALTH OF VEHICLE

(71) Applicant: NATIONAL FORMOSA UNIVERSITY, Hu-Wei Township (TW)

(72) Inventors: Tzu-Chi CHAN, Hu-Wei Township (TW); Sheng-Lun HUANG, Hu-Wei Township (TW)

(21) Appl. No.: 18/932,280

(22) Filed: Oct. 30, 2024

(30) Foreign Application Priority Data
Jul. 2, 2024 (TW) 113124719

(51) Int. Cl. G07C 5/08; G07C 5/00

(52) U.S. Cl. CPC G07C 5/0808; G07C 5/008; G07C 5/0825

(57) ABSTRACT

A vehicle system includes a vehicle and an assessing device. The vehicle includes a vehicle body, a vehicle sensor, a communication device, and a controller connected to the vehicle sensor and the communication device. The vehicle sensor is disposed on the vehicle body, and outputs a detection signal based on detection of an operation condition of the vehicle. The controller receives the detection signal, and outputs, via the communication device, a wireless signal carrying the detection signal. The assessing device includes a communication unit communicating with the communication device, and a processing unit connected to the communication unit. The processing unit performs signal processing on the detection signal carried by the wireless signal that is received via the communication unit to obtain a first output, performs feature extraction on the first output to obtain a second output, and performs health assessment based on the second output to obtain assessment data.

### CROSS-REFERENCE TO RELATED APPLICATION

This application claims priority to Taiwanese Invention patent application Ser. No. 11/312,4719, filed on Jul. 2, 2024, the entire disclosure of which is incorporated by reference herein.

### FIELD

The disclosure relates to a vehicle system and a method for assessing machine health of a vehicle.

### BACKGROUND

Vehicles such as automated guided vehicles (AGVs) or unmanned flying vehicles (also known as drones) have been widely utilized in various fields, e.g., aerial photography, aerial spraying, delivery of supplies, air patrol, etc. It should be noted that safety of using vehicles is extremely important. Environmental factors frequently influence operation of vehicles (for example, a flight trajectory of a drone may be influenced by the wind direction, the temperature, the humidity and so on), and monitoring an operation condition of a vehicle is essential for ensuring the safety of using the vehicle. Besides, when a vehicle operates in an abnormal operation condition, the vehicle may encounter a breakdown, and incur maintenance costs for the vehicle.

### SUMMARY

Therefore, an object of the disclosure is to provide a vehicle system and a method for assessing machine health of a vehicle.

According to one aspect of the disclosure, the vehicle system includes a vehicle and an assessing device.

The vehicle includes a vehicle body, a vehicle sensor, a communication device and a controller.

The vehicle sensor is disposed on the vehicle body, and is configured to detect an operation condition of the vehicle, and to output a detection signal based on detection of the operation condition of the vehicle.

The communication device is disposed on the vehicle body.

The controller is disposed on the vehicle body, is electrically connected to the vehicle sensor and the communication device, and is configured to receive the detection signal from the vehicle sensor, and to output, via the communication device, a wireless signal that carries the detection signal.

The assessing device includes a communication unit and a processing unit.

The communication unit is configured to wirelessly communicate with the communication device.

The processing unit is electrically connected to the communication unit, and stores a signal processing module, a feature-extracting module, and a health-assessing module. The health-assessing module is implemented to include at least one assessment program. The processing unit is configured to receive the wireless signal via the communication unit, to perform signal processing on the detection signal carried by the wireless signal by utilizing the signal processing module to obtain a first output, to perform feature extraction on the first output by utilizing the feature-extracting module to obtain a second output, and to perform health assessment based on the second output by executing said at least one assessment program of the health-assessing module to obtain assessment data related to machine health of the vehicle.

According to another aspect of the disclosure, the method is to be implemented by the assessing device that is previously described. The method includes steps of:
the communication unit receiving a wireless signal that carries a detection signal related to detection of an operation condition of the vehicle; the communication unit outputting the wireless signal to the processing unit; the processing unit obtaining a first output by utilizing the signal processing module to perform signal processing on the detection signal carried by the wireless signal;
the processing unit obtaining a second output by utilizing the feature-extracting module to perform feature extraction on the first output; and the processing unit obtaining assessment data related to the machine health of the vehicle by utilizing the health-assessing module to perform health assessment based on the second output.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a vehicle system according to an embodiment of the disclosure.

FIG. 2 is a block diagram illustrating the vehicle system according to the embodiment of the disclosure.

FIG. 3 is a flow chart illustrating a method for assessing machine health of a vehicle according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

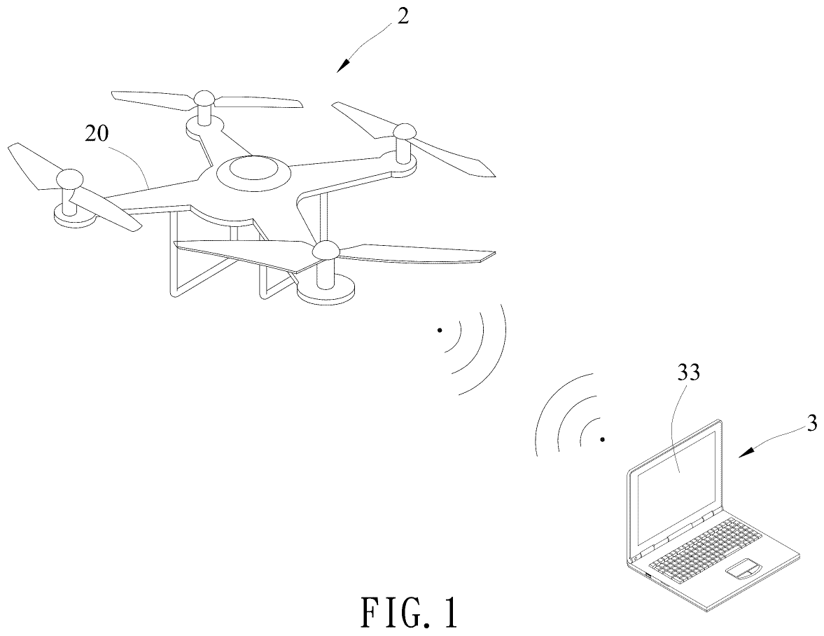

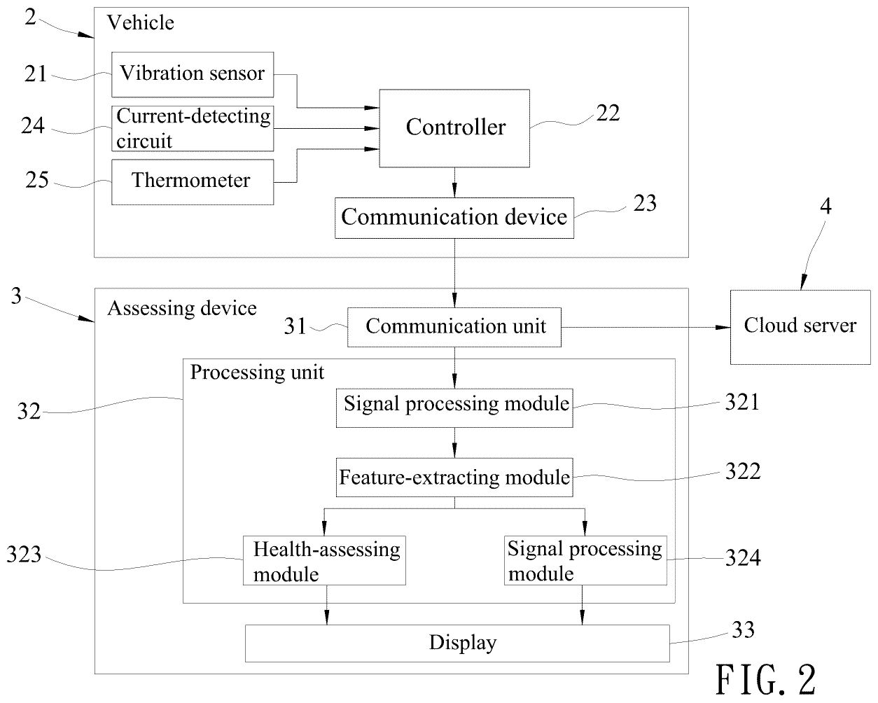

Referring to FIGS. 1 and 2, an embodiment of a vehicle system according to the disclosure is illustrated. The vehicle system includes a vehicle 2 and an assessing device 3. In some embodiments, the vehicle system further includes a cloud server 4.

The vehicle 2 may be implemented to be an automated guided vehicle (AGV) or an unmanned flying vehicle (also known as a drone), but is not limited thereto. In this embodiment, the vehicle 2 is exemplarily implemented by an unmanned flying vehicle. The vehicle 2 includes a vehicle body 20 (see FIG. 1), at least one vehicle sensor that is disposed on the vehicle body 20, a communication device 23 that is disposed on the vehicle body 20, and a controller 22 that is disposed on the vehicle body 20 and that is electrically connected to said at least one vehicle sensor and the communication device 23.

The controller 22 may be implemented by a micro control unit (MCU), or any circuit configurable/programmable in a software manner and/or a hardware manner to implement functionalities discussed in this disclosure.

The communication device 23 is implemented to be a wireless transceiver that supports wireless communication standards, such as Bluetooth® technology standards, but is not limited thereto.

Said at least one vehicle sensor is configured to detect an operation condition of the vehicle 2 and to output a detection signal based on detection of the operation condition of the vehicle 2. In particular, a frequency of detection performed by said at least one vehicle sensor is 2 Hz, and said at least one vehicle sensor outputs the detection signal every 0.5 seconds. The controller 22 is configured to receive the detection signal from said at least one vehicle sensor, and to output, via the communication device 23, a wireless signal that carries the detection signal to the assessing device 3.

In this embodiment, said at least one vehicle sensor includes a vibration sensor 21, a current-detecting circuit 24 and a thermometer 25. The vibration sensor 21 is exemplarily implemented by an accelerator. The vibration sensor 21 is configured to detect vibration of the vehicle body 20 and to output a vibration signal as the detection signal based on detection of the vibration of the vehicle body 20. The current-detecting circuit 24 is configured to detect an operation current of the vehicle 2 (e.g., an electric current flowing through a motor of the vehicle) and to output a current signal as the detection signal based on detection of the operation current. The thermometer 25 is configured to detect a temperature of the vehicle body 20 and to output a temperature signal as the detection signal based on detection of the temperature. Receiving the vibration signal, the current signal and the temperature signal, the controller 22 outputs, to the assessing device 3, the wireless signal that carries the vibration signal, the current signal and the temperature signal. It should be noted that the wireless signal may carry one of the vibration signal, the current signal, the temperature signal, and a combination thereof.

The assessing device 3 includes a communication unit 31, and a processing unit 32 that is electrically connected to the communication unit 31. In some embodiments, the assessing device 3 further includes a display 33, and the processing unit 32 is further electrically connected to the display 33.

The display 33 may be a computer monitor such as a liquid-crystal display (LCD), a light-emitting diode (LED) display, a plasma display panel, a projection display or the like. However, implementation of the display 33 is not limited to the disclosure herein and may vary in other embodiments.

The communication unit 31 is implemented to be a wireless transceiver that supports wireless communication standards, such as Bluetooth® technology standards, but is not limited thereto. The communication unit 31 is configured to wirelessly communicate with the communication device 23 of the vehicle 2 by using techniques related to the Bluetooth® technology standards. In some embodiments, the communication unit 31 is configured to communicate further with the cloud server 4 in a wireless connection or a wired connection.

The processing unit 32 may be implemented by an MCU, or any circuit configurable/programmable in a software manner and/or a hardware manner to implement functionalities discussed in this disclosure. The processing unit 32 stores a signal processing module 321, a feature-extracting module 322, a health-assessing module 323 and a performance-predicting module 324.

It should be noted that each of the signal processing module 321, the feature-extracting module 322, the health-assessing module 323 and the performance-predicting module 324 may be implemented by one of firmware, software, and any combination thereof. For example, the signal processing module 321, the feature-extracting module 322, the health-assessing module 323 and the performance-predicting module 324 may be implemented to be software modules in a program, where the software modules contain codes and instructions to carry out specific functionalities, and can be called individually or together to fulfill functions executed by the processing unit 32 of this disclosure.

The above-mentioned modules may be embodied in: executable software as a set of logic instructions stored in a machine-or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

The processing unit 32 is configured to receive the wireless signal from the vehicle 2 via the communication unit 31, to perform signal processing on the detection signal carried by the wireless signal by utilizing the signal processing module 321 to obtain a first output, to perform feature extraction on the first output by utilizing the feature-extracting module 322 to obtain a second output, and to perform health assessment based on the second output by executing at least one assessment program of the health-assessing module 323 to obtain assessment data related to machine health of the vehicle 2 (i.e., whether or not the vehicle 2 operates normally). In this way, a user of the vehicle 2 may be able to know the operation condition of the vehicle 2, to make the vehicle 2 keep stably operating in a normal operation condition (i.e., without malfunctions or abnormalities), to recognize potential issues related to operation of the vehicle 2, to prevent the vehicle 2 from breakdown, and to repair the vehicle 2 in time upon occurrence of an abnormal operation condition (i.e., with malfunctions or abnormalities) of the vehicle 2. In some embodiments, the processing unit 32 is further configured to perform prediction by utilizing the performance-predicting module 324 based on the second output to obtain prediction data related to performance (e.g., efficiency of operation) of the vehicle 2. Consequently, the user may be able to know the performance of the vehicle 2, and to make the vehicle 2 keep operating in a relatively highly efficient manner.

The signal processing module 321 is implemented to include at least one signal-processing program. Specifically, said at least one signal-processing program can be executed to realize computations related to time-domain analysis (e.g., for electric currents passing within one second, to calculate a root mean square (RMS), kurtosis, a variance, a crest factor, standard deviation, skewness, etc. thereof), frequency-domain analysis (e.g., to plot a frequency spectrum for a vibration signal), the Hilbert transform (e.g., to plot an envelope spectrum for a vibration signal), and data smoothing (e.g., to perform Kalman filtering on a group of values, or to smooth out a group of values including singular values or extreme values). In practice, the user could choose any one of said at least one signal-processing program to perform signal processing according to application needs.

The feature-extracting module 322 is implemented to include at least one feature-extracting program. Specifically, said at least one feature-extracting program can be executed to realize computations related to using the Fisher criterion to perform dimensionality reduction for feature extraction, and using principal component analysis (PCA) to perform dimensionality reduction where calculations of eigenvectors and eigenvalues are involved. In practice, the user could choose any one of said at least one feature-extracting program to perform feature extracting according to application needs.

The health-assessing module 323 is implemented to include at least one assessment program. Specifically, said at least one assessment program includes an assessment program of k-means clustering, an assessment program of a self-organizing map (SOM), an assessment program of a support vector machine (SVM), an assessment program of a genetic algorithm (GA), an assessment program of a k-nearest neighbors algorithm (k-NN) and an assessment program of a generalized regression neural network (GRNN). In practice, the user could choose any one of said at least one assessment program to perform health assessment according to application needs. The processing unit 32 is configured to execute one of the assessment programs of the health-assessing module 323 based on the second output to obtain the assessment data. In some embodiments, said at least one assessment program includes only the assessment program of k-means clustering.

The performance-predicting module 324 is implemented to include at least one prediction program. For example, the performance-predicting module 324 includes a prediction program of logistic regression, a prediction program of statistical pattern recognition, a prediction program of a Gaussian mixture model (GMM) and a prediction program of a neural network (NN). In a scenario where statistical pattern recognition is utilized, two Gaussian models respectively for an average value and a variance value that are calculated based on a vibration signal are established, and then a ratio of an overlapping area of the two Gaussian models to a total area of the two Gaussian models is determined. It is worth to note that, sometimes, a first ratio of the overlapping area of the two Gaussian models to an area of one of the two Gaussian models is determined, and a second ratio of the overlapping area of the two Gaussian models to an area of the other one of the two Gaussian models is determined. In a scenario where NN is utilized, a technique of backpropagation may be involved. In practice, the user could choose any one of said at least one prediction program to perform prediction according to application needs. The processing unit 32 is configured to execute one of the prediction programs of the performance-predicting module 324 based on the second output to obtain the prediction data.

In some embodiments, the processing unit 32 is further configured to calculate a statistical value (e.g., an average temperature) based on the detection signal by utilizing the signal processing module 321, to determine whether the statistical value satisfies a predetermined criterion (e.g., whether or not the average temperature falls within a predetermined temperature range from 70° C. to 80° C.), and to output a warning signal in response to determining that the statistical value does not satisfy the predetermined criterion. The warning signal may be implemented by generating a visual output for showing a warning message on the display 33, or by generating an audio output for playing alert sounds by a speaker or a buzzer (not shown) of the assessing device 3.

In some embodiments, the processing unit 32 is further configured to display, via the display 33, the assessment data, the prediction data and the statistical value.

In some embodiments, the processing unit 32 is further configured to send the assessment data, the prediction data and the statistical value to the cloud server 4 via the communication unit 31. In this way, the user is able to obtain the assessment data, the prediction data and the statistical value by using a remote electronic device that is in communication with the cloud server 4. At the same time, the cloud server 4 may store the assessment data, the prediction data and the statistical value for a long term for further analysis.

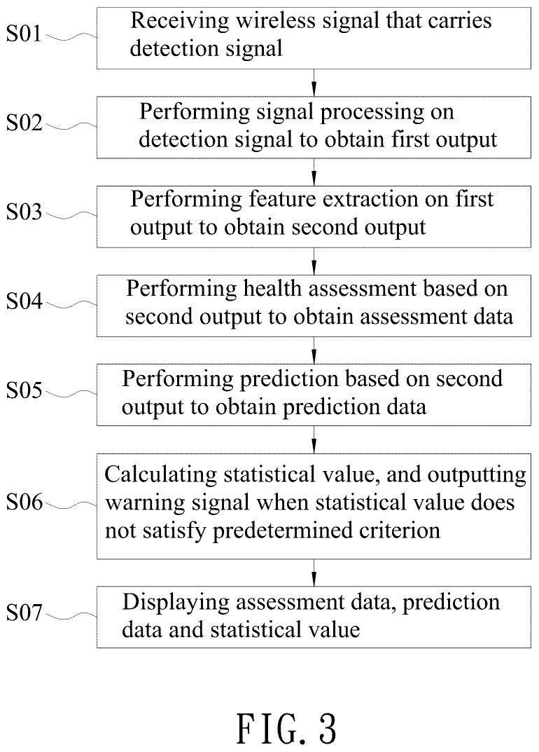

Referring to FIG. 3, an embodiment of a method for assessing machine health of a vehicle according to the disclosure is illustrated. The method is to be implemented by the assessing device 3 that is previously described. The method includes steps S01 to S07 delineated below.

In step S01, the communication unit 31 of the assessing device 3 receives the wireless signal that carries the detection signal (i.e., the vibration signal, the current signal and/or the temperature signal), and outputs the wireless signal to the processing unit 32 of the assessing device 3.

In step S02, the processing unit 32 obtains the first output by utilizing the signal processing module 321 to perform signal processing on the detection signal (i.e., the vibration signal, the current signal and/or the temperature signal) carried by the wireless signal.

In step S03, the processing unit 32 obtains the second output by utilizing the feature-extracting module 322 to perform feature extraction on the first output.

In step S04, the processing unit 32 obtains the assessment data by utilizing the health-assessing module 323 to perform health assessment based on the second output, wherein at least one of the assessment programs of k-means clustering, an SOM, an SVM, a GA, a k-NN or a GRNN is executed.

In step S05, the processing unit 32 obtains the prediction data by utilizing the performance-predicting module 324 to perform prediction based on the second output, wherein at least one of the prediction programs of logistic regression, statistical pattern recognition, a GMM or an NN is executed.

In step S06, the processing unit 32 utilizes the signal processing module 321 to calculate the statistical value based on the detection signal carried by the wireless signal, determines whether the statistical value satisfies the predetermined criterion, and outputs the warning signal in response to determining that the statistical value does not satisfy the predetermined criterion.

In step S07, the processing unit 32 displays the assessment data, the prediction data, and/or the statistical value via the display 33.

It should be noted that an order of executing steps S04 to S06 is not limited to the disclosure herein and may vary in other embodiments. In other words, the order of executing steps S04 to S06 may be arbitrarily arranged. For example, in some embodiments, step S05 is executed prior to step S04. In some embodiments, steps S04 to S06 are executed in parallel.

In some embodiments, one of steps S05 to S07 may be omitted.

An example of a procedure of using the vehicle system is provided in the following paragraphs for explanation, where the vibration signal serves as the detection signal. It should be noted that in a scenario where one of the current signal and the temperature signal serves as the detection signal, the procedure will be run in a similar manner.

At the beginning, the vehicle 2 is prepared to have the normal operation condition and an expected performance (i.e., a measured value that is related to operation and that achieves an expected threshold value). For example, the vehicle 2 may be prepared such that an electric current of a motor of the vehicle 2 falls within a normal range of electric current, a voltage of the motor of the vehicle 2 falls within a normal range of voltage, and an airspeed of the vehicle 2 is capable of achieving an expected speed.

When the vehicle 2 is operating, the vibration sensor 21 of the vehicle 2 detects vibration of the vehicle body 20 and outputs a vibration signal as the detection signal based on detection of the vibration of the vehicle body 20. Receiving the vibration signal, the controller 22 of the vehicle 2 outputs the wireless signal that carries the vibration signal to the assessing device 3 via the communication device 23 of the vehicle 2.

The communication unit 31 of the assessing device 3 receives the wireless signal that carries the detection signal (i.e., the vibration signal), and outputs the wireless signal to the processing unit 32 of the assessing device 3. The processing unit 32 utilizes the signal processing module 321 to perform signal processing (e.g., to perform frequency-domain analysis) on the detection signal (i.e., the vibration signal) carried by the wireless signal to obtain the first output. Subsequently, the processing unit 32 utilizes the feature-extracting module 322 to perform feature extraction (e.g., to perform PCA) on the first output to obtain the second output. Then, the processing unit 32 utilizes the health-assessing module 323 to perform health assessment (e.g., to execute the assessment program of k-means clustering, or to sequentially execute the assessment programs of an SVM and k-means clustering) based on the second output to obtain the assessment data (e.g., to plot a scatter diagram related to pieces of data obtained in the feature extraction). In addition, the processing unit 32 utilizes the performance-predicting module 324 to perform prediction (e.g., to execute the prediction program of a GMM) based on the second output to obtain the prediction data (e.g., to plot another scatter diagram related to pieces of data obtained in the feature extraction). Moreover, the processing unit 32 utilizes the signal processing module 321 to calculate the statistical value (e.g., an RMS value related to the vibration of the vehicle body 20) based on the detection signal carried by the wireless signal. After that, the processing unit 32 displays the assessment data, the prediction data, and/or the statistical value via the display 33. In this way, for the vehicle 2 having the normal operation condition and the expected performance, the assessment data, the prediction data, and the statistical value are obtained.

It is worth to note that for a vehicle 2 having the normal operation condition and the expected performance, a relevancy between the pieces of data obtained in the feature extraction is relatively higher, and thus distribution of data points in the scatter diagram in each of the assessment data and the prediction data would be relatively more concentrated. On the other hand, for a vehicle 2 having the abnormal operation condition and a poor performance (i.e., a measured value that is related to operation and that does not achieve the expected threshold value), a relevancy between the pieces of data obtained in the feature extraction is relatively lower, and thus the distribution of the data points in the scatter diagram in each of the assessment data and the prediction data would be relatively more scattered. Therefore, by referring to the assessment data and the prediction data that were obtained under a condition that the vehicle 2 has the normal operation condition and the expected performance, the user is able to determine whether or not the vehicle 2 currently has the normal operation condition, and determine whether or not the vehicle 2 currently has the expected performance based on the assessment data and the prediction data that are currently obtained when the vehicle 2 is in operation.

Moreover, according to the statistical value (which is a specific value, e.g., 90) thus obtained for the vehicle 2 having the normal operation condition and the expected performance, the user could determine the predetermined criterion (e.g., whether or not the statistical value falls within a range from 0 to 100). Thereafter, after calculating the statistical value that is currently obtained when the vehicle 2 is in operation, the processing unit 32 determines whether the statistical value satisfies the predetermined criterion (i.e., whether or not the statistical value currently obtained falls within the range from 0 to 100), and outputs the warning signal (i.e., generates the aforementioned visual output or the aforementioned audio output) in response to determining that the statistical value does not satisfy the predetermined criterion.

To sum up, for the vehicle system and the method for assessing machine health of the vehicle 2 according to the disclosure, said at least one vehicle sensor (for example, the vibration sensor 21, the current-detecting circuit 24 and the thermometer 25) is utilized to generate the detection signal based on detection of the operation condition of the vehicle 2, and the processing unit 32 is utilized to sequentially perform a series of functions (i.e., signal processing, feature extraction and health assessment) on the detection signal to obtain the assessment data that is related to the machine health of the vehicle 2. According to the assessment data, a user of the vehicle 2 may be able to know the operation condition of the vehicle 2, to make the vehicle 2 keep operating in the normal operation condition, to prevent the vehicle 2 from breakdown, and to repair the vehicle 2 in time upon occurrence of the abnormal operation condition of the vehicle 2. In this way, safety of using the vehicle 2 may be ensured, and maintenance costs for the vehicle 2 may be reduced.

Due to a variety of detection signals (i.e., the vibration signal, the current signal and/or the temperature signal), completeness of analysis (i.e., health assessment and performance predicting) may be ensured.

Moreover, by calculating the statistical value based on the detection signal carried by the wireless signal, and outputting the warning signal in response to determining that the statistical value does not satisfy the predetermined criterion, the user may be able to monitor the operation condition of the vehicle 2 in real-time, and to be automatically notified in time to deal with any abnormalities occurring on the vehicle 2.

Further, according to the prediction data, the user may be able to know the performance of the vehicle 2, and to make the vehicle 2 keep operating in a relatively highly efficient manner.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A vehicle system comprising:
a vehicle including
a vehicle body,
a vehicle sensor that is disposed on said vehicle body, and that is configured to detect an operation condition of said vehicle and to output a detection signal based on detection of the operation condition of said vehicle,
a communication device that is disposed on said vehicle body, and
a controller that is disposed on said vehicle body, that is electrically connected to said vehicle sensor and said communication device, and that is configured to receive the detection signal from said vehicle sensor, and to output, via said communication device, a wireless signal carrying the detection signal; and
an assessing device including
a communication unit that is configured to wirelessly communicate with said communication device, and
a processing unit that is electrically connected to said communication unit, and that stores a signal processing module, a feature-extracting module, and a health-assessing module, said health-assessing module being implemented to include at least one assessment program, said processing unit being configured to receive the wireless signal via said communication unit,
perform signal processing on the detection signal carried by the wireless signal by utilizing said signal processing module to obtain a first output,
perform feature extraction on the first output by utilizing said feature-extracting module to obtain a second output, and
perform health assessment based on the second output by executing said at least one assessment program of said health-assessing module to obtain assessment data related to machine health of said vehicle.

2. The vehicle system as claimed in claim 1, wherein said vehicle sensor is a vibration sensor configured to detect vibration of said vehicle body and to output a vibration signal as the detection signal based on detection of the vibration of said vehicle body.

3. The vehicle system as claimed in claim 1, wherein said vehicle sensor is a current-detecting circuit configured to detect an operation current of said vehicle and to output a current signal as the detection signal based on detection of the operation current.

4. The vehicle system as claimed in claim 1, wherein said vehicle sensor is a thermometer configured to detect a temperature of said vehicle body and to output a temperature signal as the detection signal based on detection of the temperature.

5. The vehicle system as claimed in claim 1, wherein said processing unit of said assessing device is further configured to calculate a statistical value based on the in detection signal by utilizing said signal processing module, and to output a warning signal in response to determining that the statistical value does not satisfy a predetermined criterion.

6. The vehicle system as claimed in claim 1, wherein said assessing device further includes a display that is electrically connected to said processing unit, and said processing unit is further configured to display the assessment data via said display.

7. The vehicle system as claimed in claim 1, wherein said processing unit of said assessing device further stores a performance-predicting module, and is further configured to perform prediction by utilizing said performance-predicting module based on the second output to obtain prediction data related to performance of said vehicle.

8. The vehicle system as claimed in claim 7, wherein said performance-predicting module includes a prediction program of logistic regression, a prediction program of statistical pattern recognition, a prediction program of a Gaussian mixture model (GMM) and a prediction program of a neural network (NN), and
wherein said processing unit is configured to execute one of the prediction programs of said performance-predicting module based on the second output to obtain the prediction data.

9. The vehicle system as claimed in claim 1, wherein said at least one assessment program includes an assessment program of k-means clustering, an assessment program of a self-organizing map (SOM), an assessment program of a support vector machine (SVM), an assessment program of a genetic algorithm (GA), an assessment program of a k-nearest neighbors algorithm (k-NN) and an assessment program of a generalized regression neural network (GRNN), and
wherein said processing unit is configured to execute one of the assessment programs of said health-assessing module based on the second output to obtain the assessment data.

10. A method for assessing machine health of a vehicle, to be implemented by an assessing device, the vehicle including a vehicle body, the assessing device including a processing unit and a communication unit that are electrically connected to each other, the processing unit storing a signal processing module, a feature-extracting module and a health-assessing module, the method comprising:
the communication unit receiving a wireless signal that carries a detection signal related to detection of an operation condition of the vehicle;
the communication unit outputting the wireless signal to the processing unit;
the processing unit obtaining a first output by utilizing the signal processing module to perform signal processing on the detection signal carried by the wireless signal;
the processing unit obtaining a second output by utilizing the feature-extracting module to perform feature extraction on the first output; and
the processing unit obtaining assessment data related to the machine health of the vehicle by utilizing the health-assessing module to perform health assessment based on the second output.

11. The method as claimed in claim 10, wherein:
the communication unit receiving a wireless signal is the communication unit receiving the wireless signal that carries a vibration signal related to vibration of the vehicle body as the detection signal; and
the processing unit obtaining a first output is to utilize the signal processing module to perform signal processing on the vibration signal carried by the wireless signal.

12. The method as claimed in claim 10, wherein:
the communication unit receiving a wireless signal is the communication unit receiving the wireless signal that carries a current signal related to an operation current of the vehicle as the detection signal; and
the processing unit obtaining a first output is to utilize the signal processing module to perform signal processing on the current signal carried by the wireless signal.

13. The method as claimed in claim 10, wherein:
the communication unit receiving a wireless signal is the communication unit receiving the wireless signal that carries a temperature signal related to a temperature of the vehicle body as the detection signal; and
the processing unit obtaining a first output is to utilize the signal processing module to perform signal processing on the temperature signal carried by the wireless signal.

14. The method as claimed in claim 10, the processing unit further storing a performance-predicting module, the method further comprising:
the processing unit obtaining prediction data related to performance of the vehicle by utilizing the performance-predicting module to perform prediction based on the second output.

15. The method as claimed in claim 14, the performance-predicting module including a prediction program of logistic regression, a prediction program of statistical pattern recognition, a prediction program of a Gaussian mixture model (GMM) and a prediction program of a neural network (NN), wherein the processing unit obtaining prediction data is to execute one of the prediction programs of the performance-predicting module based on the second output.

16. The method as claimed in claim 10, the health-assessing module including an assessment program of k-means clustering, an assessment program of a self-organizing map (SOM), an assessment program of a support vector machine (SVM), an assessment program of a genetic algorithm (GA), an assessment program of a k-nearest neighbors algorithm (k-NN) and an assessment program of a generalized regression neural network (GRNN), wherein the processing unit obtaining assessment data is to execute one of the assessment programs of the health-assessing module based on the second output.

17. The method as claimed in claim 10, further comprising:
the processing unit utilizing the signal processing module to calculate a statistical value based on the detection signal carried by the wireless signal; and
the processing unit outputting a warning signal in response to determining that the statistical value does not satisfy a predetermined criterion.

18. The method as claimed in claim 10, the assessing device further including a display that is electrically connected to the processing unit, the method further comprising:
the processing unit displaying the assessment data via the display.
